(19) United States
(12) Patent Application Publication
(10) Pub. No.: US 2017/0300062 A1
(43) Pub. Date: Oct. 19, 2017

(54) PARKING ASSISTANCE DEVICE FOR VEHICLE AND PARKING CONTROL METHOD THEREOF

(71) Applicant: MANDO CORPORATION, Pyeongtaek-si (KR)

(72) Inventor: Tak Gen KIM, Seongnam-si (KR)

(21) Appl. No.: 15/487,900

(22) Filed: Apr. 14, 2017

(30) Foreign Application Priority Data
Apr. 15, 2016 (KR) 10-2016-0046364

(51) Int. Cl. G05D 1/02

(52) U.S. Cl. CPC G05D 1/0255

(57) ABSTRACT

Provided are a parking assistance device for a vehicle and a parking control method thereof, capable of preventing collision with an obstacle by determining characteristics of an obstacle located within a parking space upon parallel parking assistance and setting an accurate parking reference line. The parking assistance device for assisting parallel parking to a parking space found through an ultrasonic sensor installed in a vehicle includes an electronic control unit configured to determine characteristics of an obstacle located within the parking space according to whether more than one echo signal of the ultrasonic sensor reflected from the obstacle occurs or not, and to control a behavior of the vehicle such that the vehicle is parallel-parked within a parking reference line set according to the determined characteristics of the obstacle.

### CROSS-REFERENCE(S) TO RELATED APPLICATION

This application claims the benefit of Korean Patent Application No. 10-2016-0046364, filed on Apr. 15, 2016, in the Korean Intellectual Property Office, the disclosure of which is incorporated herein in its entirety by reference.

### BACKGROUND OF THE INVENTION

### Field of the Invention

The present invention relates to a parking assistance device for a vehicle and a parking control method thereof, and more particularly, to a parking assistance device for a vehicle and a parking control method thereof, capable of preventing collision with an obstacle by determining characteristics of an obstacle located within a parking space upon parallel parking assistance and setting an accurate parking reference line.

### Description of the Related Art

Recently, an automatic parking control technology for assisting parking has been developed. Such an automatic parking control technology searches around a space for parking of a vehicle, such that the vehicle is parked in the space, calculates a parking route according to the found result, and performs steering control according to the parking route to assist the parking of the vehicle.

A parking assistance device searches for a parking space, sets a parking reference line, and performs parking control such that a vehicle does not deviate a preset allowable error based on the set parking reference line.

However, when assisting parallel parking, an existing parking assistance device equally sets the parking reference line regardless of a curb, which is a low obstacle, or a wall, which is a high obstacle, within a parking space. Thus, upon parallel parking in the parking space around which the low curb is located, it is likely that the vehicle will collide with the curb.

That is, when an obstacle located within the parking space is a wall as illustrated in FIG. 1B, there is no difference between an actual distance to the wall and a measurement distance P to the wall measured through an ultrasonic sensor installed in the vehicle. On the other hand, when an obstacle is a curb as illustrated in FIG. 1A, a measurement distance L to the curb measured through an ultrasonic sensor installed in the vehicle is different from an actual distance (L cos θ) to the curb.

In the case of tuning to set the parking reference line based on the wall, a distance spaced apart from the measurement distance to the curb by a reference width (reference width when set based on the wall, for example, 30 cm) is set as the parking reference line. Thus, as illustrated in FIG. 2A, it is likely that the vehicle will collide with the curb. In the case of tuning to set the parking reference line based on the curb, a distance spaced apart from the measurement distance to the wall by a reference width (reference width when set based on the curb, for example, 45 cm) is set as the parking reference line. Thus, as illustrated in FIG. 2B, the vehicle is parked at a position much spaced apart from the wall. This is not an efficient use of the parking space.

### PRIOR ART DOCUMENT

### Patent Document

(Patent Document 1) Korean Patent Application Publication No. 10-2012-0040789 (published on Apr. 30, 2012), entitled “PARKING ASSISTANCE METHOD AND SYSTEM THEREFOR”

### SUMMARY OF THE INVENTION

An aspect of the present invention is directed to provide a parking assistance device for a vehicle and a parking control method thereof, capable of preventing collision with an obstacle by determining characteristics of an obstacle located within a parking space upon parallel parking assistance and setting an accurate parking reference line.

According to an embodiment of the present invention, a parking assistance device for assisting parallel parking to a parking space found through an ultrasonic sensor installed in a vehicle includes an electronic control unit configured to determine characteristics of an obstacle located within the parking space according to whether more than one echo signal of the ultrasonic sensor reflected from the obstacle occurs or not, and to control a behavior of the vehicle such that the vehicle is parallel-parked within a parking reference line set according to the determined characteristics of the obstacle.

According to another embodiment of the present invention, a parking assistance method of a parking assistance device for assisting parallel parking to a parking space found through an ultrasonic sensor installed in a vehicle includes: transmitting a signal from the ultrasonic sensor toward the parking space; receiving an echo signal corresponding to the transmitted signal reflected from the obstacle within the parking space; determining characteristics of the obstacle according to whether more than one echo signal occurs or not in the receiving the echo signal; and setting a parking reference line according to the determined characteristics of the obstacle.

### BRIEF DESCRIPTION OF THE DRAWINGS

FIGS. 1 and 2 are diagrams for describing an existing parking assistance device.

FIG. 3 is a block diagram of a parking assistance device according to an embodiment of the present invention.

FIG. 4 is a block diagram of an electronic control unit illustrated in FIG. 3.

FIG. 5 is a flowchart of a parking control method of a parking assistance device according to an embodiment of the present invention.

FIG. 6 is a diagram illustrating echo signals responding to transmission signals respectively transmitted to a curb and a wall.

FIG. 7 is a diagram illustrating a parking reference line set with respect to each obstacle according to an embodiment of the present invention.

### DETAILED DESCRIPTION OF EMBODIMENTS

Hereinafter, preferred embodiments of the present invention will be described in detail with reference to the accompanying drawings.

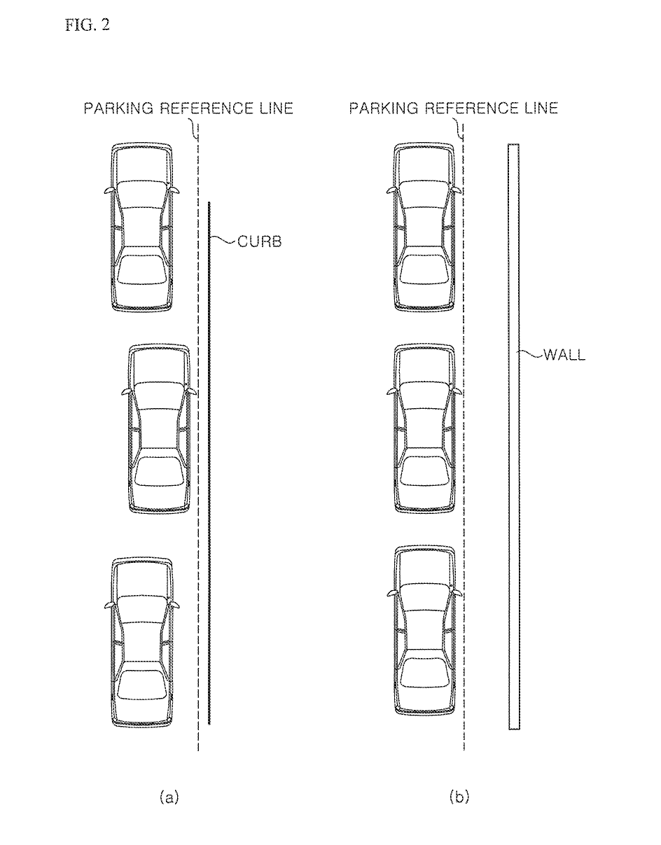

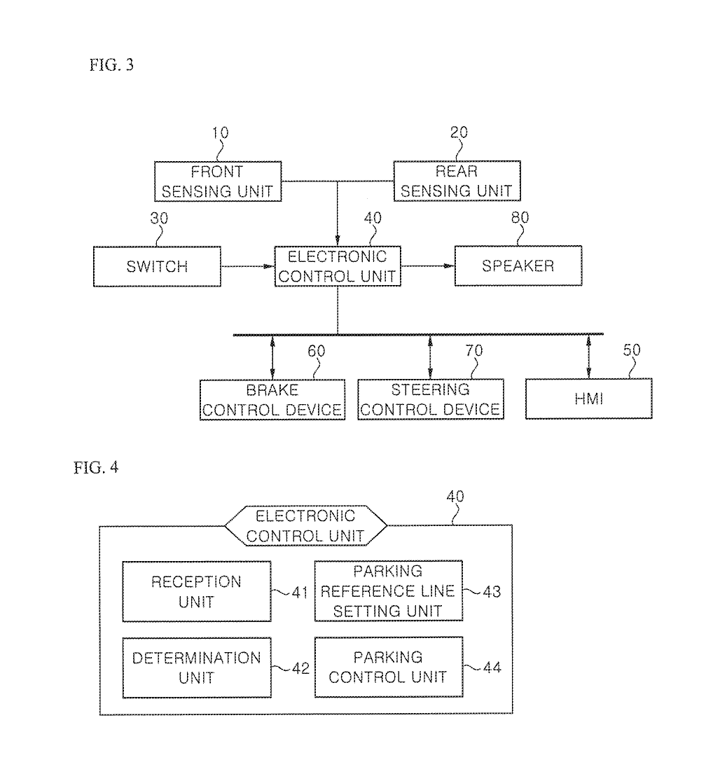

FIG. 3 is a block diagram of a parking assistance device according to an embodiment of the present invention, and FIG. 4 is a block diagram of an electronic control unit illustrated in FIG. 3.

Referring to FIG. 3, the parking assistance device according to the embodiment of the present invention includes a front sensing unit 10 installed on a front side of a vehicle, a rear sensing unit 20 installed on a rear side of the vehicle, an electronic control unit 40 connected to the front sensing unit 10 and the rear sensing unit 20, a switch 30 configured to select a parking mode, a speaker 80 configured to output an alarm or notification information, and a brake control device 60 and a steering control device 70 configured to control a behavior of the vehicle to perform automatic parking to a found parking space under control of the electronic control unit 40.

In addition, the parking assistance device according to the embodiment of the present invention may include a human-machine interface (HMI) 50 configured to display a parking state or vehicle condition information on a display device (not illustrated) under control of the electronic control unit 40.

The front sensing unit 10 and the rear sensing unit 20 may be ultrasonic sensors configured to receive echo ultrasonic signals reflected from an object and measure a distance to the object. The parking electronic control unit 40 receives sensing signals sensed through the front sensing unit 10 and the rear sensing unit 20.

The front sensing unit 10 may be installed at each of a center and corners of the front side of the vehicle and may be provided in plurality. Similarly, the rear sensing unit 20 may be installed at each of a center and corners of the rear side of the vehicle and may be provided in plurality.

Upon parallel parking control in a parallel parking control mode selected from preset parking control modes (for example, a perpendicular parking control mode, a parallel parking control mode, and the like), the electronic control unit 40 searches for the parking space by using the measurement information measured through the front sensing unit 10 and the rear sensing unit 20. When the found parking space is determined as an available parking space, the electronic control unit 40 displays the parking space and outputs a gear shift notification notifying a gear shift to “R”. Then, the electronic control unit 40 obtains a position of a vehicle and a position of an obstacle at a start point entering the parking space, and performs parking control such that the vehicle is located within a parking reference line set to be spaced apart from the obtained position of the obstacle by a certain distance. The parallel parking is one selected from left parallel parking and right parallel parking.

In particular, the electronic control unit 40 determines characteristics of the obstacle according to a presence or absence of two or more echo signals in a reception signal (hereinafter, referred to as an “echo signal”) corresponding to the transmission signal transmitted toward the parking space from the front sensing unit 10 (hereinafter, referred to as an “ultrasonic sensor”) installed at the corner of the front side of the vehicle entering the parking space during the parallel parking control and then reflected from the obstacle located within the parking space, and controls the behavior of the vehicle such that the vehicle is parallel-parked within the parking reference line set according to the determined characteristics of the obstacle.

Referring to FIG. 4, the electronic control unit 40 includes a reception unit 41, a determination unit 42, a parking reference line setting unit 43, and a parking control unit 44.

The reception unit 41 receives a parking mode selection signal of the switch 30. In addition, the reception unit 41 receives sensing signals sensed through the ultrasonic sensor 10. Furthermore, upon parallel parking control according to the selection of the parallel parking control mode, the reception unit 41 receives echo signals corresponding to transmission signals transmitted from the ultrasonic sensor 10 toward the parking space and reflected from the obstacle located within the parking space. The determination unit 42 determines a presence or absence of two or more echo signals in the echo signal received by the reception unit, that is, a presence or absence of a second echo signal. When the transmission signal transmitted from the ultrasonic sensor 10 toward the parking space collides with an obstacle such as a curb that is lower in height than the ultrasonic sensor 10, the transmission signal is reflected from the collided obstacle only once to generate one echo signal, that is, a first echo signal. On the other hand, when the transmission signal transmitted from the ultrasonic sensor 10 toward the parking space collides with a flat obstacle such as a wall or another vehicle, which is equal to or higher in height than the ultrasonic sensor 10, the transmission signal is reflected between the vehicle with the ultrasonic sensor 10 mounted thereon and the obstacle several times to generate two or more echo signals, that is, a first echo signal, a second echo signal, and the like. The echo signal received for the first time by the reception unit 41 is referred to as a first echo signal, and the echo signal received for the second time by the reception unit 41 is referred to as a second echo signal. In order to increase accuracy of measurement, only the echo signal, whose voltage exceeds a preset threshold value (Th), among the echo signals received by the reception unit 41 may be taken into account.

Therefore, the determination unit 42 determines whether an obstacle is a high obstacle that is equal to or higher in height than the ultrasonic sensor 10, or a low obstacle that is lower in height than the ultrasonic sensor 10, according to a presence or absence of the second echo signal. In particular, when the distance calculated by the second echo signal among the echo signals received by the reception unit 41 is twice the distance calculated by the first echo signal, the determination unit 42 recognizes the corresponding obstacle as a wall. Otherwise, the determination unit 42 may recognize other obstacles (for example, another vehicle).

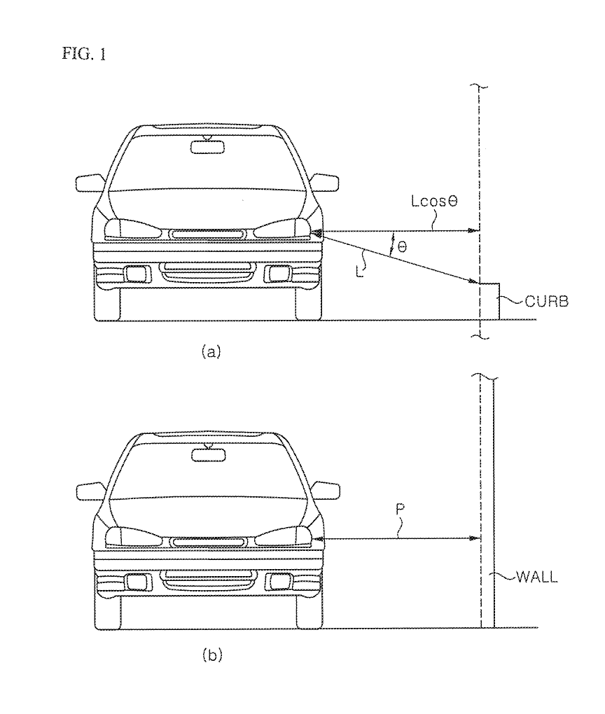

When the determination unit 42 determines that the second echo signal is not present in the received echo signal, the parking reference line setting unit 43 sets the parking reference line by compensating a difference between the measurement distance (L in FIG. 1) to the obstacle calculated by the first echo signal and the actual distance to the obstacle, i.e., a vertical radiation angle (θ) of the ultrasonic sensor 10. When the determination unit 42 determines that the second echo signal is present in the received echo signal, the parking reference line setting unit 43 sets the parking reference line based on the measurement distance (L) to the obstacle measured by the first echo signal.

More specifically, when the second echo signal is not present in the received echo signal, the parking reference line setting unit 43 may calculate the actual distance (L cos θ in FIG. 1) to the obstacle by using “the measurement distance (L) to the obstacle by the first echo signal” and “mounting position information of the front sensing unit 10”, and set the parking reference line based on the calculated actual distance to the obstacle, or may set the parking reference line by subtracting a preset compensation distance (for example, 30 cm) from the measurement distance to the obstacle by the first echo signal. In this case, the mounting position information of the ultrasonic sensor 10 may include a mounting height, a mounting direction, and the like of the sensor and may be stored in a memory (not illustrated). The compensation distance may be determined in advance by experience based on the mounting position information of the ultrasonic sensor 10.

The parking reference line setting unit 43 calculates the vertical component (L sin θ) of the measurement distance (L) to the obstacle by the first echo signal by using Equation 1 below.

L sin θ=Sensor Mounting Height−Curb Height [Equation 1]

In Equation 1 above, the sensor mounting height is a mounting height from the ground to the ultrasonic sensor 10, the curb height is an average height of the curb, for example, a value preset to be 10 cm, and L is the measurement distance from the ultrasonic sensor 10 to the obstacle by the first echo signal. Thus, the vertical radiation angle of the ultrasonic sensor 10, that is, the angle θ between the ultrasonic sensor 10 and the curb is calculated by using Equation 1.

The parking reference line setting unit 43 reflects the calculated angle θ to calculate the horizontal component of the measurement distance (L) to the obstacle, that is, the actual distance (L cos θ) from the ultrasonic sensor 10 to the obstacle.

In particular, when the determination unit 42 determines that the second echo signal is not present in the received echo signal, the parking reference line setting unit 43 may calculate the actual distance (L cos θ in FIG. 1) to the obstacle by using “the measurement distance (L) to the obstacle by the first echo signal” and “mounting position information of the front sensing unit 10”, and set a distance obtained by subtracting the preset parking reference width from the calculated actual distance (L cos θ) as the parking reference line. When the determination unit 42 determines that the second echo signal is present in the received echo signal, the parking reference line setting unit 43 may set a distance obtained by subtracting the preset parking reference width from the measurement distance (L) to the obstacle by the first echo signal as the parking reference line

The parking control unit 44 performs parking control such that the vehicle is located within the parking reference line set by the parking reference line setting unit 43. In addition, the parking control unit 44 determines whether a parallel parking completion condition is satisfied, based the angle of the vehicle and the position of the vehicle. When the parallel parking completion condition is satisfied, the parking control unit 44 may output parking completion information notifying parking completion to the HMI 50. When the parallel parking completion condition is not satisfied, the parking control unit 44 may control the behavior of the vehicle to satisfy the parallel parking completion condition. In addition, when the vehicle is located on the set parking reference line, the parking control unit 44 may output an alarm or notification information through the speaker 80 so as to notify to a driver that the vehicle is close to the obstacle.

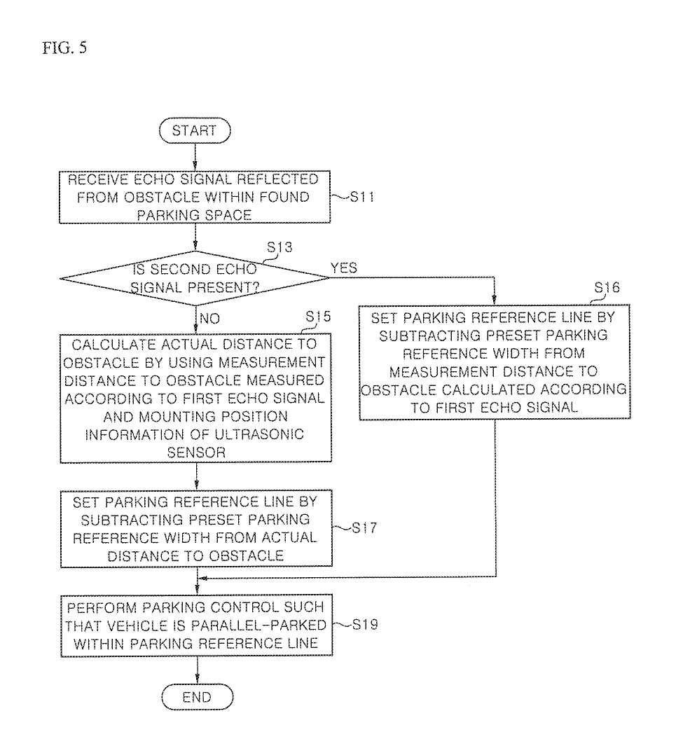

A parking control method of the parking assistance device configured as above will be described below with reference to FIG. 5.

FIG. 5 is a flowchart of the parking control method of the parking assistance device according to an embodiment of the present invention.

Referring to FIG. 5, upon parallel parking control, the electronic control unit 40 receives echo signals corresponding to transmission signals transmitted from the ultrasonic sensor 10 toward a found parking space and reflected from the obstacle located within the parking space (S11).

The electronic control unit 40 determines a presence or absence of two or more echo signals in the received echo signals, that is, a presence or absence of a second echo signal (S13). The second echo signal is preferably an echo signal that passes a preset threshold value for the second time.

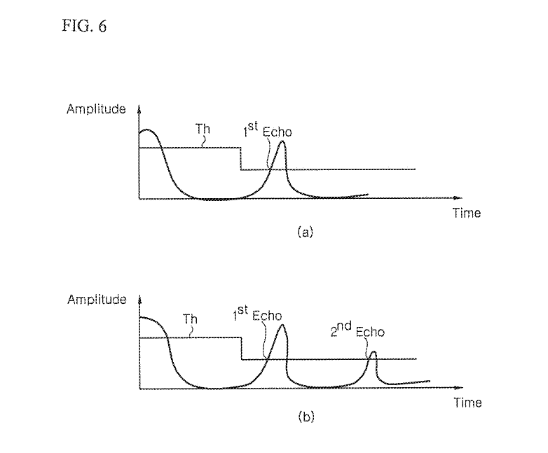

FIG. 6A is a graph showing an echo signal reflected from a low obstacle. As can be seen from FIG. 6A, the first echo signal passing the preset threshold value (Th) for the first time is generated, but the second echo signal passing the preset threshold value (Th) is not generated. FIG. 6B is a graph showing an echo signal reflected from a high obstacle. As can be seen from FIG. 6B, after the first echo signal, the second echo signal passing the preset threshold value (Th) is generated.

When it is determined in operation S13 that the second echo signal is not present in the received echo signal, the electronic control unit 40 calculates the actual distance to the obstacle by using the measurement distance to the obstacle measured according to the first echo signal and the mounting position information of the ultrasonic sensor 10 (S15). As described above, a case where the second echo signal is not present in the received echo signal is a case where a low obstacle is located within the parking space, and there is a difference between the measurement distance to the obstacle and the actual distance to the obstacle. Therefore, it is necessary to set the parking reference line by compensating the difference between the measurement distance to the obstacle and the actual distance to the obstacle.

Then, as described above, the electronic control unit 40 sets the parking reference line based on the actual distance to the obstacle calculated by using Equation 1 (S17). By setting the accurate parking reference line according to characteristics of the obstacle, it is possible to remove the possibility of collision with the low obstacle during parallel parking.

When it is determined in operation S13 that the second echo signal is present in the received echo signal, the electronic control unit 40 sets the parking reference line based on the measurement distance to the obstacle measured according to the first echo signal (S16). A case where the second echo signal is present in the received echo signal is a case where a high obstacle is located within the parking space, and there is no difference between the measurement distance to the obstacle and the actual distance to the obstacle. Therefore, the parking reference line is set based on the measurement distance to the obstacle.

The electronic control unit 40 performs parking control such that the vehicle is parallel-parked within the parking reference line set through operation S16 or S17 (S19).

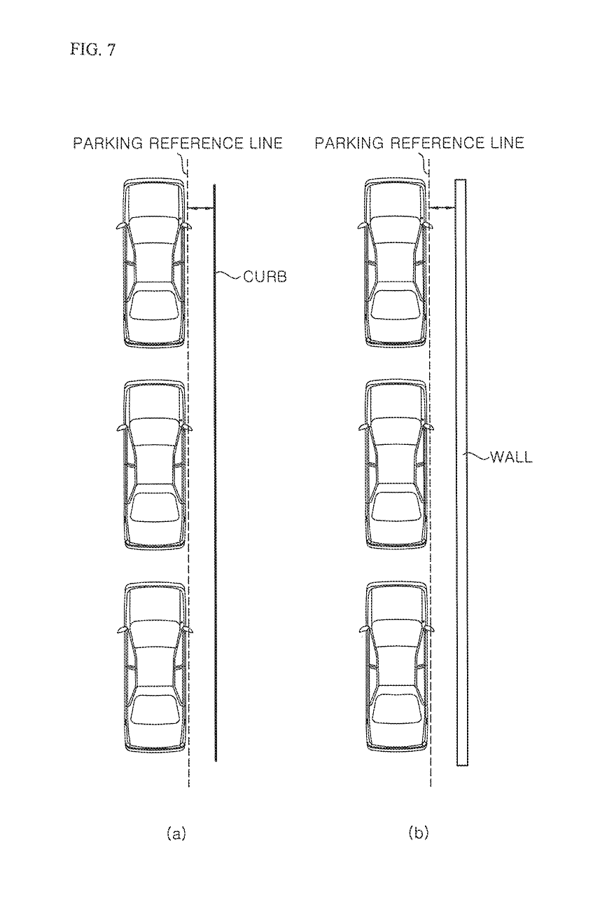

In this manner, when a low obstacle is located within the parking space as illustrated in FIG. 7A, the actual distance to the obstacle is calculated by using the measurement distance to the obstacle measured through the ultrasonic sensor and the mounting position information of the ultrasonic sensor, and the parking reference line is set based on the calculated actual distance. Then, the behavior of the vehicle is controlled such that the vehicle is parked within the set parking reference line, thereby removing the possibility of collision with the obstacle. When a high obstacle is located within the parking space as illustrated in FIG. 7B, the parking reference line is set based on the measurement distance to the obstacle measured through the ultrasonic sensor, and the behavior of the vehicle is controlled such that the vehicle is parked within the set parking reference line, thereby achieving the efficient use of the parking space without being parked at a position much spaced apart from the wall.

According to the embodiments of the present invention, it is possible to prevent collision with the obstacle by determining characteristics of the obstacle located within the parking space upon parallel parking assistance and setting the accurate parking reference line.

In particular, when the obstacle such as the curb is located within the parking space, the actual distance to the curb is calculated by reflecting the mounting position information of the ultrasonic sensor to the measurement distance to the curb measured through the ultrasonic sensor, and the parking reference line is set based on the calculated actual distance, thereby preventing collision with the curb.

Also, when the obstacle such as the wall is located within the parking space, the parking reference line is set based on the measurement distance to the wall measured through the ultrasonic sensor, thereby achieving the efficient use of the parking space.

While the embodiments of the present invention have been described with reference to the specific embodiments, it will be apparent to those skilled in the art that various changes and modifications may be made without departing from the spirit and scope of the invention as defined in the following claims.

DESCRIPTION OF REFERENCE NUMERALS

| | |
|---|---|
| 10: front sensing unit | 20: rear sensing unit |
| 30: switch | 40: electronic control unit |
| 41: reception unit | 42: determination unit |
| 43: parking reference line setting unit | 44: parking control unit |
| 50: HMI | 60: brake control device |
| 70: steering control device | 80: switch |

1. A parking assistance device for assisting parallel parking to a parking space found through an ultrasonic sensor installed in a vehicle, the parking assistance device comprising:
an electronic control unit configured to determine characteristics of an obstacle located within the parking space according to whether more than one echo signal of the ultrasonic sensor reflected from the obstacle occurs or not, and to control a behavior of the vehicle such that the vehicle is parallel-parked within a parking reference line set according to the determined characteristics of the obstacle.

2. The parking assistance device according to claim 1, wherein the electronic control unit comprises:
a reception unit configured to receive the echo signal corresponding to the transmission signal transmitted from the ultrasonic sensor toward the parking space and then reflected from the obstacle within the parking space;
a determination unit configured to determine whether more than one echo signal of the ultrasonic sensor is received or not by the reception unit; and
a parking reference line setting unit configured to recognize that a height of the obstacle is lower than a height of the ultrasonic sensor if the determination unit determines that only one echo signal is received, to recognize that the height of the obstacle is equal to or higher than the height of the ultrasonic sensor if the determination unit determines that more than one echo signal is received, and to differently set the parking reference line according to the height of the obstacle.

3. The parking assistance device according to claim 2, wherein, if it is recognized that the height of the obstacle is lower than the height of the ultrasonic sensor, the parking reference line setting unit sets the parking reference line by compensating a vertical radiation angle of the ultrasonic sensor from a measurement distance to the obstacle measured by the one echo signal, and if it is recognized that the height of the obstacle is equal to or higher than the height of the ultrasonic sensor, the parking reference line setting unit sets the parking reference line based on a measurement distance to the obstacle measured by the first one of the more than one echo signal.

4. The parking assistance device according to claim 2, wherein the electronic control unit further comprises a parking control unit configured to perform parking control such that the vehicle is located within the parking reference line set by the parking reference line setting unit.

5. The parking assistance device according to claim 2, wherein, if it is recognized that the height of the obstacle is lower than the height of the ultrasonic sensor, the parking reference line setting unit calculates an actual distance to the obstacle by using a measurement distance to the obstacle measured by the one echo signal and mounting position information of the ultrasonic sensor, and sets the parking reference line based on the calculated actual distance to the obstacle.

6. The parking assistance device according to claim 5, wherein the parking reference line setting unit sets the parking reference line by subtracting a preset parking reference width from the calculated actual distance to the obstacle.

7. The parking assistance device according to claim 2, wherein, if it is recognized that the height of the obstacle is lower than the height of the ultrasonic sensor, the parking reference line setting unit sets the parking reference line by subtracting a preset compensation distance from the measurement distance to the obstacle measured by the one echo signal.

8. A parking assistance method of a parking assistance device for assisting parallel parking to a parking space found through an ultrasonic sensor installed in a vehicle, the parking assistance method comprising:
transmitting a signal from the ultrasonic sensor toward the parking space;
receiving an echo signal corresponding to the transmitted signal reflected from the obstacle within the parking space;
determining characteristics of the obstacle according to whether more than one echo signal occurs or not in the receiving the echo signal; and
setting a parking reference line according to the determined characteristics of the obstacle.

9. The parking assistance method according to claim 8, wherein the determining of the characteristics of the obstacle comprises recognizing that a height of the obstacle is lower than the height of the ultrasonic sensor if only one echo signal is received, and recognizing that the height of the obstacle is equal to or higher than the height of the ultrasonic sensor if more than one echo signal is received.

10. The parking assistance method according to claim 9, wherein the setting of the parking reference line comprises:
if it is recognized that the height of the obstacle is lower than the height of the ultrasonic sensor, setting the parking reference line by compensating a vertical radiation angle of the ultrasonic sensor from a measurement distance to the obstacle measured by the one echo signal; and
if it is recognized that the height of the obstacle is equal to or higher than the height of the ultrasonic sensor, setting the parking reference line based on a measurement distance to the obstacle measured by the first one of the more than one echo signal.

11. The parking assistance method according to claim 9, further comprising performing parking control such that the vehicle is located within the set parking reference line.

12. The parking assistance method according to claim 9, wherein the setting of the parking reference line comprises:
if it is recognized that the height of the obstacle is lower than the height of the ultrasonic sensor, calculating an actual distance to the obstacle by using a measurement distance to the obstacle measured by the one echo signal and mounting position information of the ultrasonic sensor; and
setting the parking reference line based on the calculated actual distance to the obstacle.

13. The parking assistance method according to claim 12, wherein the setting of the parking reference line comprises setting the parking reference line by subtracting a preset parking reference width from the calculated actual distance to the obstacle.

14. The parking assistance method according to claim 9, wherein, if it is recognized that the height of the obstacle is lower than the height of the ultrasonic sensor, the setting of the parking reference line comprises setting the parking reference line by subtracting a preset compensation distance from the measurement distance to the obstacle measured by the one echo signal.
